(19) United States
(12) Patent Application Publication
(10) Pub. No.: US 2012/0139841 A1
(43) Pub. Date: Jun. 7, 2012

(54) User Interface Device With Actuated Buttons

(75) Inventors: Stuart Taylor, Cambridge (GB); Jonathan Hook, Newcastle upon Tyne (GB); David Alexander Butler, Cambridge (GB); Shahram Izadi, Cambridge (GB); Nicolas Villar, Cambridge (GB); Stephen Edward Hodges, Cambridge (GB)

(73) Assignee: Microsoft Corporation, Redmond, WA (US)

(21) Appl. No.: 12/957,897

(22) Filed: Dec. 1, 2010

(51) Int. Cl. G06F 3/02

(52) U.S. Cl. 345/168

(57) ABSTRACT

A user interface device with actuated buttons is described. In an embodiment, the user interface device comprises two or more buttons and the motion of the buttons is controlled by actuators under software control such that their motion is inter-related. The position or motion of the buttons may provide a user with feedback about the current state of a software program they are using or provide them with enhanced user input functionality. In another embodiment, the ability to move the buttons is used to reconfigure the user interface buttons and this may be performed dynamically, based on the current state of the software program, or may be performed dependent upon the software program being used. The user interface device may be a peripheral device, such as a mouse or keyboard, or may be integrated within a computing device such as a games device.

### BACKGROUND

Most computer users use a mouse and keyboard to interact with the software running on a computer and the functionality of a computer mouse has remained almost unchanged for many years. The mouse and keyboard, which are just two examples of user interface devices, enable a user to provide user input to the software through depressing buttons or keys or by scrolling a wheel or moving the mouse. Other than an audible click when a mouse button is depressed or a scroll wheel rotated, these devices do not provide the user with any feedback.

With the advent of touch-sensitive displays, users can now interact directly with the software graphical user interface and some computing devices now offer on-screen keyboards in addition to, or instead of, a physical keyboard. As a user of an on-screen keyboard does not experience the sensation of pressing down a key, some on-screen keyboards offer haptic feedback in the form of a small vibration (e.g. using the vibration alert motor contained in a mobile telephone) when a key press is detected by the on-screen keyboard software.

The embodiments described below are not limited to implementations which solve any or all of the disadvantages of known user interface devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A user interface device with actuated buttons is described. In an embodiment, the user interface device comprises two or more buttons and the motion of the buttons is controlled by actuators under software control such that their motion is inter-related. The position or motion of the buttons may provide a user with feedback about the current state of a software program they are using or provide them with enhanced user input functionality. In another embodiment, the ability to move the buttons is used to reconfigure the user interface buttons and this may be performed dynamically, based on the current state of the software program, or may be performed dependent upon the software program being used. The user interface device may be a peripheral device, such as a mouse or keyboard, or may be integrated within a computing device such as a games device.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows two examples of user interface devices comprising actuators;

FIG. 2 is a flow diagram of an example method of operation of a user interface device, such as those shown in FIG. 1;

FIG. 3 is a schematic diagram of a servo motor;

FIG. 4 shows example profiles of button resistance against button position;

FIG. 5 is a schematic diagram of a modified servo motor;

FIG. 6 is a schematic diagram showing the inference of pressure on a button based on servo position;

FIG. 7 shows various examples of user interface device reconfiguration; and

FIG. 8 illustrates various components of an exemplary improved user interface device which may be connected to or integral with a computing-based device.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

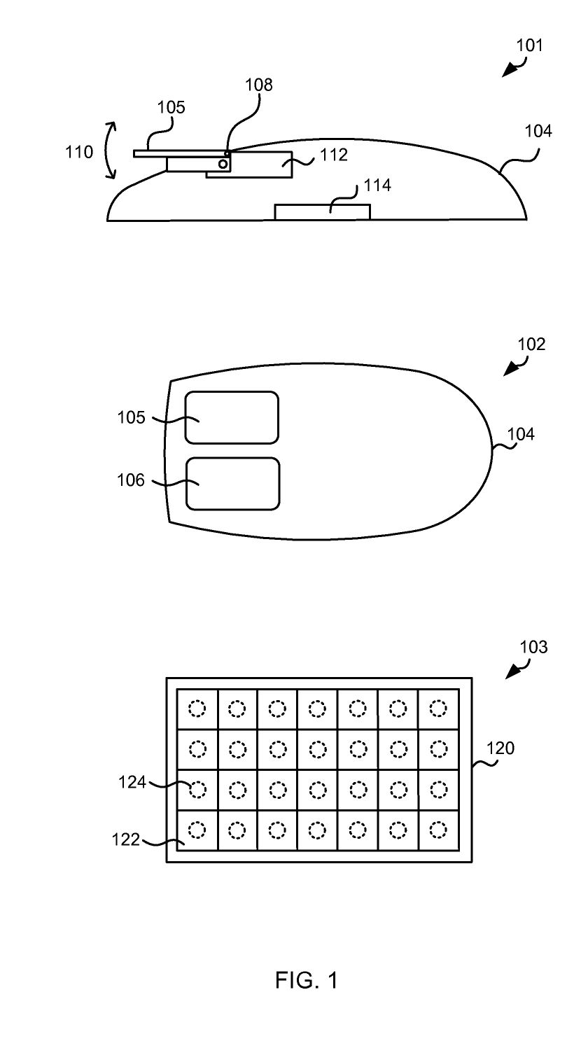

FIG. 1 shows two examples of user interface devices comprising actuators which, when actuated, change the physical position of one or more physical buttons (which may also be referred to as keys) under software control and where the position or motion of at least two buttons is linked or inter-related in some way. The first example of such a user interface device is an improved mouse which is shown in the first two schematic diagrams 101, 102 (the first diagram 101 shows a cross-section view and the second diagram 102 shows a view of the mouse from above) and the second example is an improved keyboard which is shown in the third schematic diagram 103. It will be appreciated that these diagrams show only those features of the user interface devices which are relevant to describing the improvements to such devices and that such improved user interface devices may comprise other elements (e.g. a computer mouse may also comprise a scroll-wheel, circuitry etc) not shown in FIG. 1. Additionally, for reasons of clarity, the improved keyboard shown in diagram 103 only has a small number of keys. It will be appreciated that the keyboard may have the same number and layout of keys as a standard QWERTY keyboard (with or without a number pad) or the keyboard may have any other arrangement and/or number of keys.

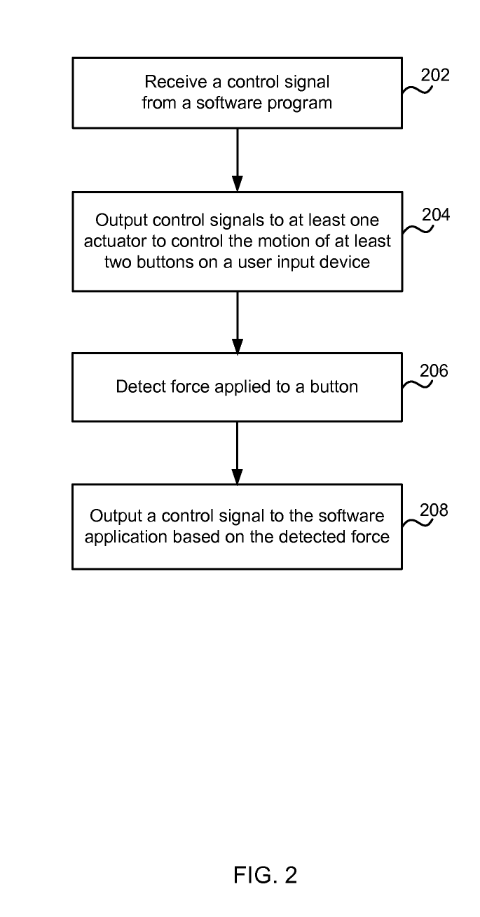

The improved mouse device 104, shown in diagrams 101, 102, comprises two buttons 105, 106 (although only one of the buttons is visible in diagram 101) which are mounted on a shaft 108 along one edge and about which they can pivot (as indicated by double-ended arrow 110). The mouse 104 also comprises at least one actuator 112 (which may be an electro-mechanical actuator) which is operable to change the physical position of the buttons 105, 106. In this example, the mouse comprises two actuators 112 with each one being positioned below one of the buttons 105, 106 such that when actuated, each actuator 112 moves one of the buttons 105, 106. The motion of the buttons is controlled such that the position of the two buttons is inter-related (or linked). The mouse may further comprise an interface element 114, which receives signals from a software program running on a computing device (block 202) and converts these into control signals for the actuators (block 204), as shown in the flow diagram of FIG. 2. In some embodiments, the mouse may not comprise an interface element 114 and in such an instance, the interface may be incorporated within a computing device to which the mouse is connected and control signals sent directly to the actuators 112.

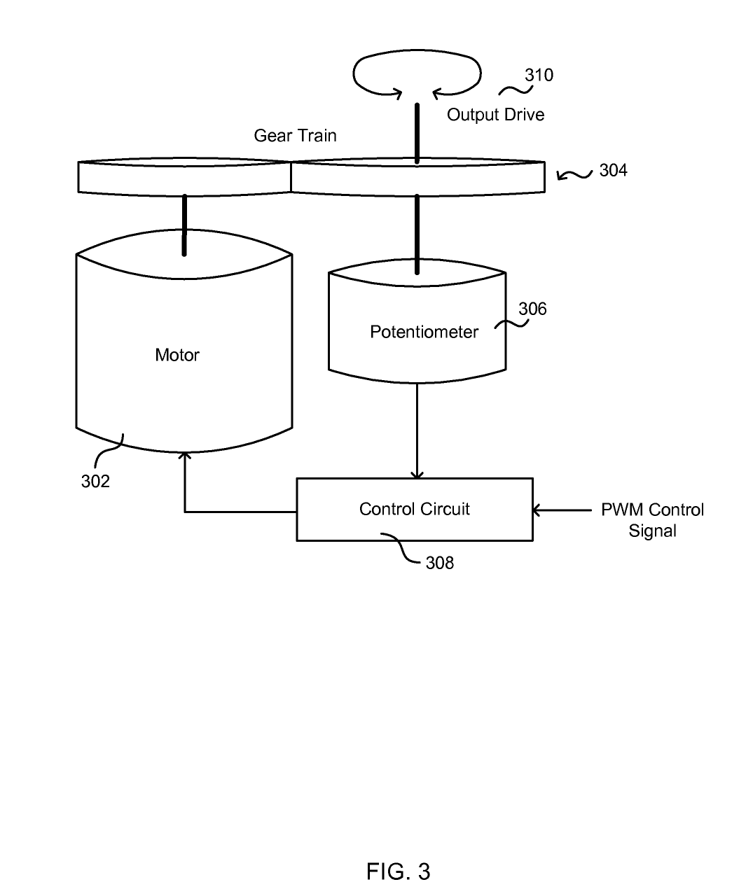

In an example implementation, the actuators 112 are small servo motors which, as shown in FIG. 3, comprise a DC motor 302, gear train 304, position sensing potentiometer 306, control circuitry 308 and a physical output drive 310. The position/rotation of the physical output drive 310 is controlled by applying a pulse-width modulated (PWM) signal to the servo motor and an example device allows the position of the physical output drive 310 to be set approximately between 0 and 180°. Further examples of actuators 112 are described below with reference to the improved keyboard 120; however any of the actuators described herein may be used for any of the examples described herein.

The improved keyboard 120, shown in diagram 103, comprises a plurality of buttons 122, which may also be referred to as keys, and an actuator (as indicated by dotted circle 124) associated with each key. Each actuator 124 is operable to move its associated key 122 under software control, e.g. to any position in a range between a non-depressed ‘normal’ position and a retracted position (which may be such that the key looks as if it has been depressed). As described above in relation to the improved mouse device, the motion of the keys is controlled such that the position or motion of two or more keys is inter-related (or linked). Although it is not visible in FIG. 1, the keyboard may further comprise an interface element which receives signals from a software program running on a computing device (block 202) and converts these into control signals for the actuators (block 204), as shown in the flow diagram of FIG. 2. Alternatively, the interface functionality may be incorporated within a computing device to which the keyboard is connected and control signals sent directly from the computing device to the actuators.

In an example implementation of an improved keyboard, the actuators 124 may comprise solenoids or piezo-electric air pump actuators (e.g. the Microblower provided by the Murata Manufacturing Co., Limited) or other piezo-electric or shape-memory alloy based actuators (e.g. bimorph actuators or those provided by Murata Manufacturing Co., Limited). In another example, a voice-coil motor may be used as an actuator (potentially in combination with a magnetic Hall Effect sensor to determine the position of the device) and further examples of actuators are described above with reference to the improved mouse device 104.

FIG. 1 shows just two examples of user interface devices which comprise actuators that are arranged to change the physical position of two or more physical buttons on the device under software control and where the position or motion of at least two buttons is linked or inter-related in some way. Other examples of user interface devices include games controllers and other types of pointing devices (e.g. trackballs, joysticks, etc.). The examples described above are peripheral devices for a computer or games console; however, the use of actuators to control the physical position of physical (as opposed to soft) buttons is also applicable to other types of user interface device, such as user interface devices which are connected to other types of computing devices (e.g. in car controls for a car management computer) or which are integrated devices (e.g. gaming devices where the games console and the controller are integrated into a single unit such as a portable or hand-held gaming device).

The actuators in a user interface device (such as actuators 112, 124 in FIG. 1) may be actuated to control the motion of buttons (under software control and where the motion/position of two or more buttons is inter-related) to provide a user interface device with new or improved functionality. The control of the motion of the buttons may, for example, result in a button moving (i.e. the position of a button changing) or result in a button moving in a different way when a user applies pressure. The position/motion of the buttons may be dependent upon one or more factors such as the software program with which a user is interacting (e.g. an application or game) and its state/context (e.g. the current on-screen task), the cursor position etc. Examples of this new or improved functionality include:
providing feedback to the user about the state/context of a software program;
reconfiguring the user interface device; and/or
enhancing the user input provided by the user interface device.
   Although these three different functions are described separately below, it will be appreciated that a single user interface device with actuators to control the positions of buttons may provide more than one of these functions, e.g. an improved mouse which provides feedback to the user and also enables enhanced user input, an improved keyboard which is reconfigurable and enables enhanced user input or an improved games controller which provides feedback to the user, is reconfigurable (e.g. depending on the game or game level being played) and enables enhanced user input.

There are many examples of ways that the motion of two or more buttons may be inter-related (or linked) and the nature of the relationship (or linking) may depend on the functionality which is being provided and a number of examples are provided below. It will be appreciated that this is not an exhaustive set of examples and in further examples, the examples of inter-related motion or position of buttons set out below may be combined or used in relation to provision of different functionalities.

In some examples a group of buttons may be moved in a linked manner under software control so that their relative position to each other does not change (and in such an example, a single actuator may be used to move all of the buttons or there may be multiple actuators which are controlled together). Any movement may be independent of any actuation of a button by the user (e.g. where the user feels or views the button position or motion), for example where this is being used to reconfigure a user interface device, or the movement may be in response to user actuation of a button (e.g. in response to a user depressing one button, a set of buttons may automatically be depressed using the actuators within the user interface device). In some examples a group of buttons may move substantially simultaneously but in other examples the inter-related motion may result in buttons moving at different times (e.g. sequentially).

In one example, when a user moves one button, this motion is detected and one or more actuators are controlled (e.g. by an interface element within the user interface device) so as to move at least one other button in a corresponding (i.e. same or similar) manner (e.g. two or more buttons may move in synchronization with each other). This may enable groups of keys to be configured to operate as a single unit, such that if a user depresses one key in the group, all the other keys in the group are moved (by their associated actuators) by the same amount (and in the same way) as the depressed key.

In another example, when a user depresses one button, one or more other buttons are retracted (so that they cannot be depressed) based on which button the user depressed. This may be used to remove options which are no longer available to a user or for training/guidance purposes, as described in more detail below.

In a further example, when a user moves one button downwards, this motion is detected and one or more actuators are controlled so as to move at least one other button is moved upwards by a similar (or identical) amount. Such operation may be referred to as ‘volumetric mode’. In this mode of operation, the positions of all the buttons in the group which includes the user actuated button are related so that they cannot be greater than a defined ‘volume’. If in an example, the group comprises two buttons and a total ‘volume’ of one, if one button is moved by a user from a position 0.5 to 0.2, then the other button is moved by an actuator (under software control) from 0.5 to 0.8. The connection of two buttons in this manner results in a see-saw like configuration where the depression of one button by a user results in the other rising and this situation may be extended to a group of more than two buttons.

Further examples of the ways that the motion/position of buttons are inter-related are described below with reference to the particular functions which they provide. Although the examples described herein refer principally to vertical motion of buttons (i.e. changing the button height), this is by way of example only and the buttons may in addition, or instead, move laterally or in any other manner. Provision of feedback to the user

As described above, existing user interface devices, such as mice and keyboards, allow a user to provide user input to a computing device but do not provide any feedback to the user about the state or context of the software program (which may be an operating system or application) which is being used. Any feedback that is provided is limited to confirmatory sounds or sensations to confirm that a button (which may also be referred to as a ‘key’, particularly in relation to a keyboard) has been pressed. Through use of the actuators (e.g. actuators 112, 124 described above), an improved user interface device as described herein can provide feedback to the user about the state/context of the software program being used by changing the physical position of buttons on the user interface device and/or through changing the resistance felt by a user when pressing a button. The feedback provided to a user may comprise haptic feedback, force feedback, guidance feedback or any other type of feedback. In many examples described below, the position of the buttons is changed by raising or lowering the button (e.g. as indicated by arrow 110 in diagram 101 of FIG. 1) but in other examples, the lateral position of a button may be changed (in addition to or instead of changing the vertical position of the button).

There are many examples of the types of feedback that may be provided to a user by the changing positions of buttons in an improved user interface device comprising actuators. In a first example, as a user uses the user interface device (which may be a mouse or other pointing device) to move a cursor over a geographic map (e.g. within an application such as www.bing.com/maps) the height of both the mouse buttons may be changed together to indicate the elevation at the location under the on-screen cursor. In a second example, the height of both the mouse buttons may be changed to provide feedback about the current state of game-play, (e.g. with the height of the buttons being dependent upon the remaining ammunition levels of a user in a first-person shooter game), or the task being undertaken by the user.

In other examples, the feedback may indicate to a user which actions are recommended and which actions are not recommended (or not so highly recommended) when navigating through a software program, e.g. when a user places the cursor over a selection, which may be a button or an item in a menu, that is highly recommended, the buttons may be moved upwards, and when a user places the cursor over a selection that is not recommended, the buttons may be moved downwards (e.g. which may give an impression to the user that the buttons are ‘shrinking away’ from them). Alternatively, the buttons may have a default ‘low’ position when the cursor is not over a button or link which can be clicked upon (e.g. corresponding to the arrow icon in a web browser) and may be raised when the curser is placed over a button or link (e.g. corresponding to a pointing finger icon in a web browser). This functionality may be particularly useful for visually impaired users (possibly in combination with screen reader technology) to aid navigation.

In yet another example, the relative positions of the two buttons 105, 106 may provide a user with tactile feedback on the position of a scroll bar, slider or rotary knob. In a default or central position, both buttons may be at the same height (i.e. level) and as the user presses one button down to change the position in one direction, the actuators may be used to raise the other button such that at an extreme position, one button is in its lowest position and the other button is in its highest position. Consequently by placing two fingers on the mouse a user can feel intuitively the position of the control and adjust it as required by pressing on the appropriate button. Such a feature may also enable fine control by a user of the position of the element within the graphical user interface (GUI) being controlled (e.g. the scroll bar, slider or rotary knob) and this is an example of how a feature can provide multiple benefits which go across the various example applications described herein.

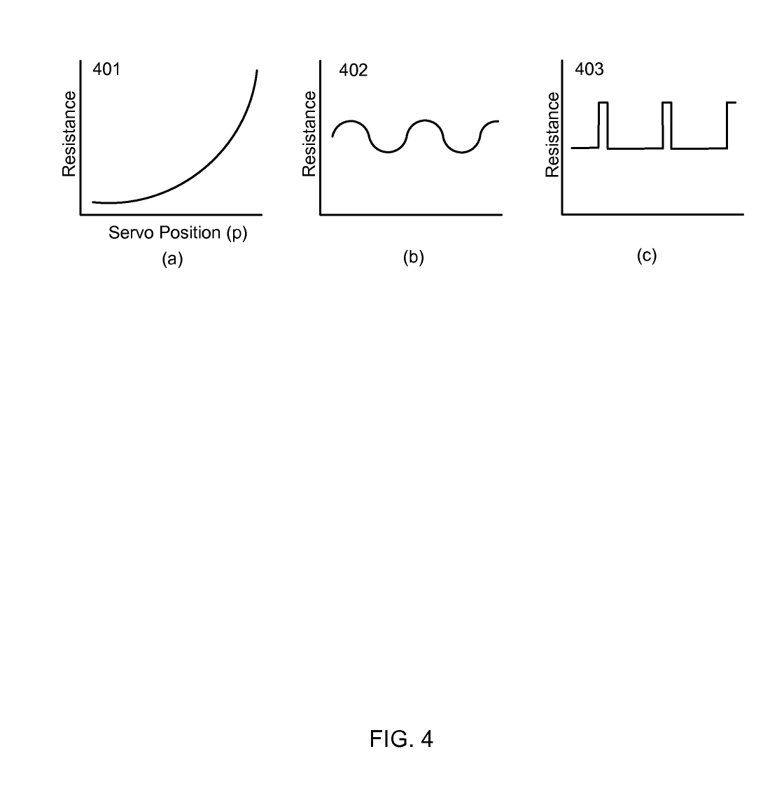

Feedback may also be provided to a user by controlling the motion of a button to change the response of the button to user applied pressure and various examples are shown in FIG. 4 which comprises three graphs of resistance (on the y-axis) against button position (on the x-axis). In other examples, the x-axis may alternatively represent the user's applied force. By changing the resistance of the button to motion by the user using the actuators associated with the buttons, any resistance force profile may be generated: the first graph 401 shows a resistance profile for a spring, the second graph 402 shows a resistance profile for a bumpy (or undulating) surface and the third graph 403 shows a resistance profile which provides a user with haptic feedback of position increments in a continuous parameter scale.

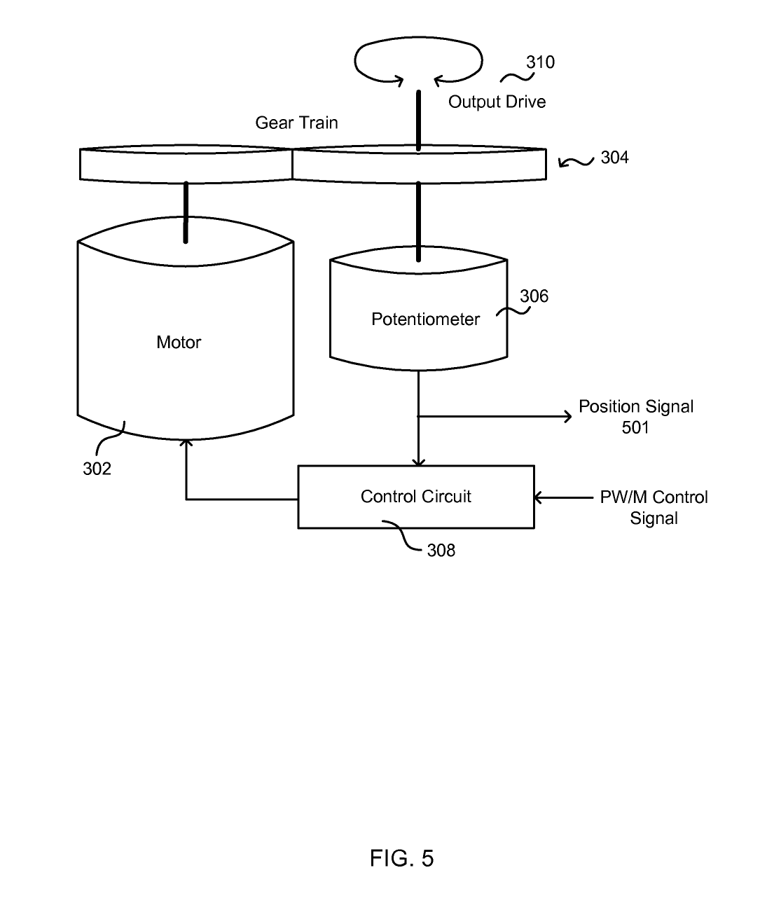

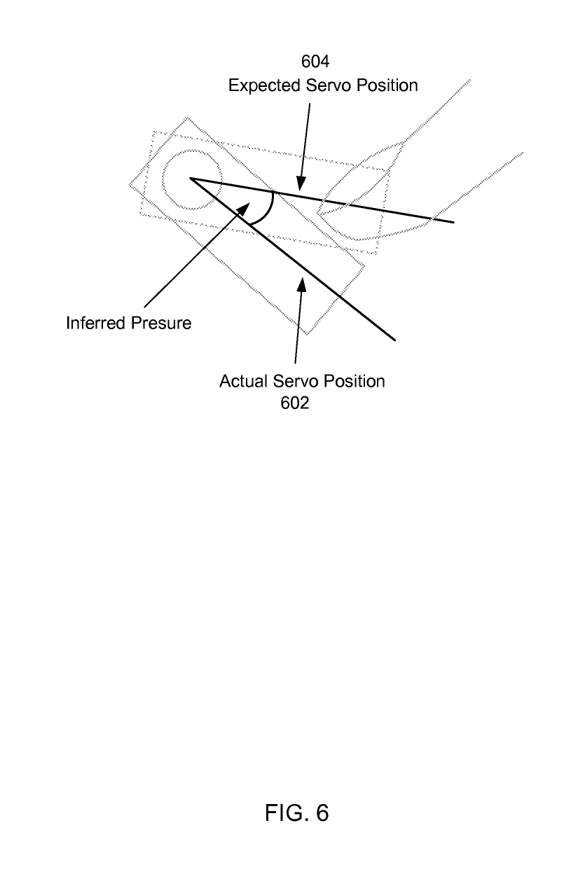

In an example implementation where the actuators comprise servo motors, the applied external force may be measured using the potentiometer's own position signal 501, as shown in FIG. 5 which is a modification of FIG. 3 (described above). The applied external force is computed by comparing the actual position 602 of the physical output drive 310 (derived from the position sensing potentiometer signal 501) to the expected position 604 based upon the last PWM command sent to the servo (as shown graphically in FIG. 6). Any difference between these two values is considered to result from a force being applied to the output drive. The direction of the applied force can be inferred from the sign of the difference between these values. Due to the finite time it takes the output drive to move to a new position following a new PWM command being sent to the servo, in an example implementation, the externally applied force is not measured until after a short ‘settling’ time.

Where such an implementation is used to generate the resistance feedback (e.g. as shown in the graphs of FIG. 4), the servo's position may be continually determined (by its potentiometer reading 501) using the following equation:

PositionChange=(ExpectedPosition−ActualPosition)−R(p)

where R(p) is the resistance force which is dependent upon the servo position p (e.g. as shown in FIG. 4). In the simplest case where R(p) is always 0, the servo will actuate to whatever position the servo has been manually pushed to by the user and no resistance feedback is provided. If however a positive value is given to R(p), the movement to the actual position will be decreased; thus resisting the user's pressure. Additionally if a pressure value less than R(p) is applied to the servo then it will actuate in the opposite direction by an amount:

R(p)−(ExpectedPosition−ActualPosition)

This gives the button behavior similar to a spring (as shown in graph 401). By varying the value of R(p), it is possible to create a varied profile of resistance throughout the movement of the servo which could be used to simulate a more realistic spring that behaves according to Hooke's law or to simulate another profile (e.g. as shown in the other graphs 402, 403 in FIG. 4). The required force profile may be stored in a look-up table that specifies a sequence of resistance force values that change as the servo is moved.

In an example application, the resistance feedback described above may be used in a sculpting application to provide a user with tactile feedback which conveys the physical properties of the sculpting material.

The improved user interface devices described herein may be used to provide a user with guidance feedback, for example when training a user to use particular software. In such an example, the buttons may be actuated so as to guide the user to press the correct button and where dependent upon the state or context of the application, buttons which should not be pressed by the user next are retracted or otherwise moved out of position. There are many applications where this ‘training mode’ may be implemented, for example, in teaching a user to touch type where a user is given a passage of text to type and keys are retracted as the user types characters so that only the correct button is available to press or so that buttons around the correct button are retracted and cannot be accidentally pressed. In other examples, the resistance feedback may be adjusted such that it is harder to press incorrect keys (i.e. more pressure is required) or if a user presses an incorrect key, the correct key may be moved (e.g. upwards). In another application, the improved user interface device may comprise an electronic musical instrument (e.g. a guitar, keyboard or wind instrument) and keys may be actuated to guide a user to depress the correct next keys to play a tune (in a corresponding manner to the typing example above). Where the improved user interface is used to provide guidance feedback to the user, the user may also be provided with an indication of their accuracy.

### Reconfiguration of the User Interface Device

Existing user interface devices are not reconfigurable and the physical arrangement of buttons cannot be changed. Through use of the actuators (e.g. actuators 112, 124 described above), an improved user interface device as described herein can be reconfigured by moving, hiding or retracting (which may also be referred to as ‘depressing’, i.e. so that they cannot be pressed by a user) buttons under software control or by grouping buttons together so that they function as a single unit (as mentioned above). This reconfiguration may remove options which are not available at a particular time (e.g. as a physical equivalent of graying out options in the GUI) and in which case the buttons may be considered ‘state-aware’. The reconfiguration may, in addition or instead, provide a user with a larger area button (comprising a group of buttons) to touch.

The reconfiguration may be used to simplify the user interface device in a customizable way and this may be used to make an interface more suitable for a particular application, to reduce errors and/or to transform a user interface device for different access abilities (e.g. for young children or users with reduced dexterity, visual acuity, etc or for users with physical impairments). The ability to reconfigure the user interface device may make the improved user interface device suited to safety critical applications (e.g. for medical devices or safety systems in industrial plants) or environments or situations where a user needs to react and make a decision quickly (e.g. vehicle controls). In some examples, the reconfiguration of the physical keys may be combined with the use of a new flexible skin or cover which may be placed over the existing keyboard to further change the visual appearance of the reconfigurable keyboard.

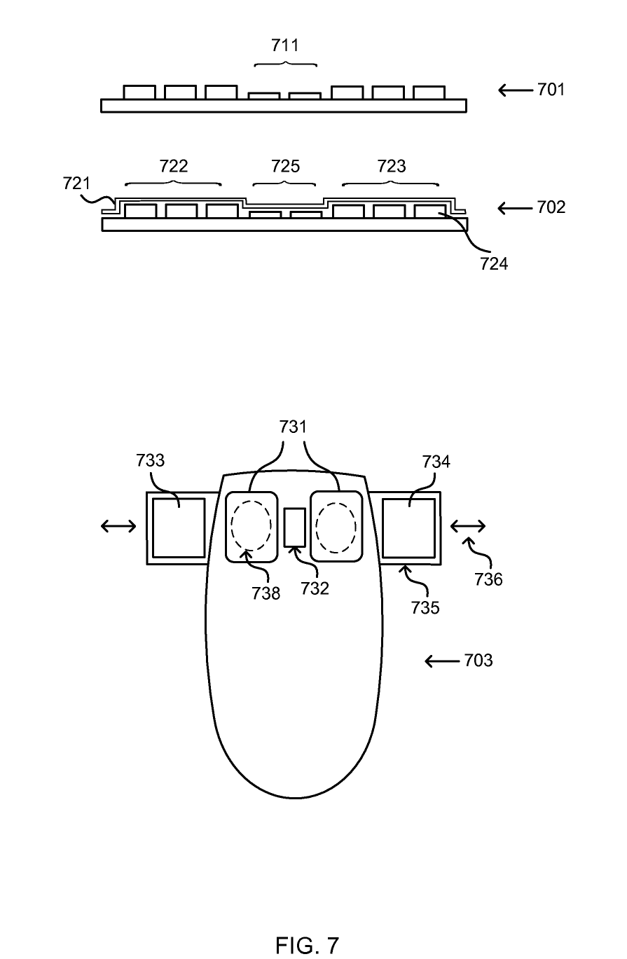

Various examples of user interface device reconfiguration can be described with reference to FIG. 7. In a first example 701, a group of keys 711 are retracted under software control using the actuators associated with these keys. Once retracted, a user cannot depress these keys to provide user input. As described above, the group of keys 711 may be retracted for a short period of time to provide dynamic reconfiguration of a user interface device as they correspond to options which are not currently available to the user (e.g. because of a selection or made by a user) or they may be retracted for a longer period of time.

In this latter situation, a flexible skin 721 may be used to provide alternative labeling for the reconfigured user interface device, as shown in the second example 702, where one ‘button’ 722, 723 from a user perspective may comprise a group of individual buttons 724 which are arranged to move together (and may therefore be referred to as a ‘composite button’). Once the skin 721 is fitted over the keyboard, each composite button 722, 723 appears to a user to be just a single large button. In the example shown in FIG. 7, one composite button 722 may be labeled ‘YES’ and the other composite button 723 may be labeled ‘NO’. In another example, the keyboard may be reconfigured and a skin applied to transform what might previously appear to be a QWERTY keyboard into an easy to use navigation device with buttons marked ‘LEFT’, ‘RIGHT’, ‘UP’ and ‘DOWN’. It will be appreciated that these are just two examples and the keyboard may be reconfigured in any way. In an example application, the keyboard may be integrated within a mobile telephone and may be provide full a QWERTY keyboard for some applications, such as text entry (e.g. for sending of emails or text messages etc) but may be reconfigured to simplify the interface for other applications such as game playing, dialing a number, entering a PIN (personal identification number) etc.

In the second example 702 shown in FIG. 7, the retracted group of buttons 725 may be used to provide additional separation of the new composite buttons 722, 723 to increase ease of use by a user. The additional separation reduces the accuracy with which a user needs to press a button because if they miss-hit a button (e.g. button 722) and instead hit one of the retracted buttons (from group of buttons 725), no user input will be detected and the user can have a second attempt at hitting the correct button.

The third example 703, in FIG. 7 shows a mouse with the standard arrangement of buttons 731 and a scroll wheel 732. In addition the mouse has two further buttons 733, 734 which are on arms 735 which are retractable. Actuators within the device (not visible in FIG. 4) are adapted to move the arms 735 under software control (as indicated by the double ended arrows 436) either so that they extend out from the mouse such that the additional buttons 733, 734 are visible and accessible to a user (as in the arrangement shown in FIG. 7) or so that the arms are retracted within the mouse housing such that the additional buttons 733, 734 are not visible to a user (and in this example the device resembles a standard computer mouse). In an example application, the arms 735 may be extended when a user is using a particular software application (which may be a computer game) which is designed to operate with the four buttons 731, 733, 734. In another example application the mouse may be used to replace another user interface device such as a dedicated games controller which typically has more buttons than a standard mouse and when used for game play, the additional buttons 733, 734 may be extended and made accessible to a user. In a further example, buttons may be retracted when a user interface device is picked up (or the resistance force changed to make the buttons essentially inoperable as the required force is very large). This may be useful where the user interface device can be operated on a surface or in-hand, such as a wireless presenter mouse, to avoid a user from inadvertently clicking on buttons when holding the device.

### Enabling Enhanced User Input

In addition to, or instead of, providing new functionalities through the movement of buttons using actuators, the improved user interface devices may enable enhanced user input, for example by detecting user applied pressure, as shown in FIG. 2. In such an arrangement, the buttons act as an input sensing device to detect user applied pressure, for example using the technique as described above with reference to FIGS. 5 and 6. As shown in FIG. 2, in some examples, the force applied to the buttons may be detected (block 206) and this force used to provide a user input (in the form of a control signal) to the software program (block 208). Where the user interface device comprises an interface element (e.g. interface element 114 in FIG. 1) this user input in the form of a control signal comprises data which is representative of the detected force. There are many ways that this force data may be used as an input and in one example it may be used as a confidence indicator in relation to a choice made by the user (e.g. with a firm press of a button which makes the choice indicating a higher level of confidence than a lighter press of the button).

In another example, as described above, the relative motion of two buttons may be used to provide user input and this may enable finer, more accurate control by a user than is achievable using a single button. The relative motion may also be used to provide relative scrolling of a scroll bar or other control compared to absolute scrolling which may be enabled by a user pressing down both buttons together.

In a further example of an enhanced user input which may be provided where the buttons can be actuated under software control, buttons may be controlled to move back to a mid-position (or another position, such as a highest position) when the button reaches the end stop at its lowest position. This may, for example, be used where the two mouse buttons are pressed down together to scroll down a window. When they reach the end stop on the buttons travel, the actuators cause the buttons to move to a higher position to enable a user to continue to scroll downwards if required. The device may be arranged to cause this resetting of the button positions in response to a particular detected user input, e.g. when a user presses down hard on both buttons (e.g. in a reaction which may be a trampoline-like effect). Such a detected user input may be mapped to a particular control in a software program, for example, the ‘Undo’ function. In a variation of this, one button may be used to lock the position of a second button with either button then being used to act as a release for the locked button. In an example application where a user wishes to scroll through a long document, they may press a first button when hovered over the ‘scroll down’ button on the GUI and then press a second button to ‘lock’ the first button in position. This would result in continuous scrolling of the document down until the user pressed either of the buttons.

In a further example, the buttons on a user interface device (e.g. an improved mouse) may be adapted to move both downwards when pressed by a user and upwards when pressure is released. In one example, where the force on a button is measured (as described above), an applied force will cause a button to move downwards. When the pressure on the button is released by the user, the button may be actuated to move upwards until a threshold pressure is detected or the button reaches its highest position end stop. In another example, the buttons may have sensors (for example, as marked by the dotted outlines 738 in the third diagram 703 of FIG. 7 and which may be capacitive sensors) which are able to detect a finger hovering over the button and a button may be actuated (in response to detection of a finger above the sensor) to move upwards to where a finger is. Such an example enables a user to control the motion of a button in both downwards and upwards directions.

### Block Diagram of an Example System

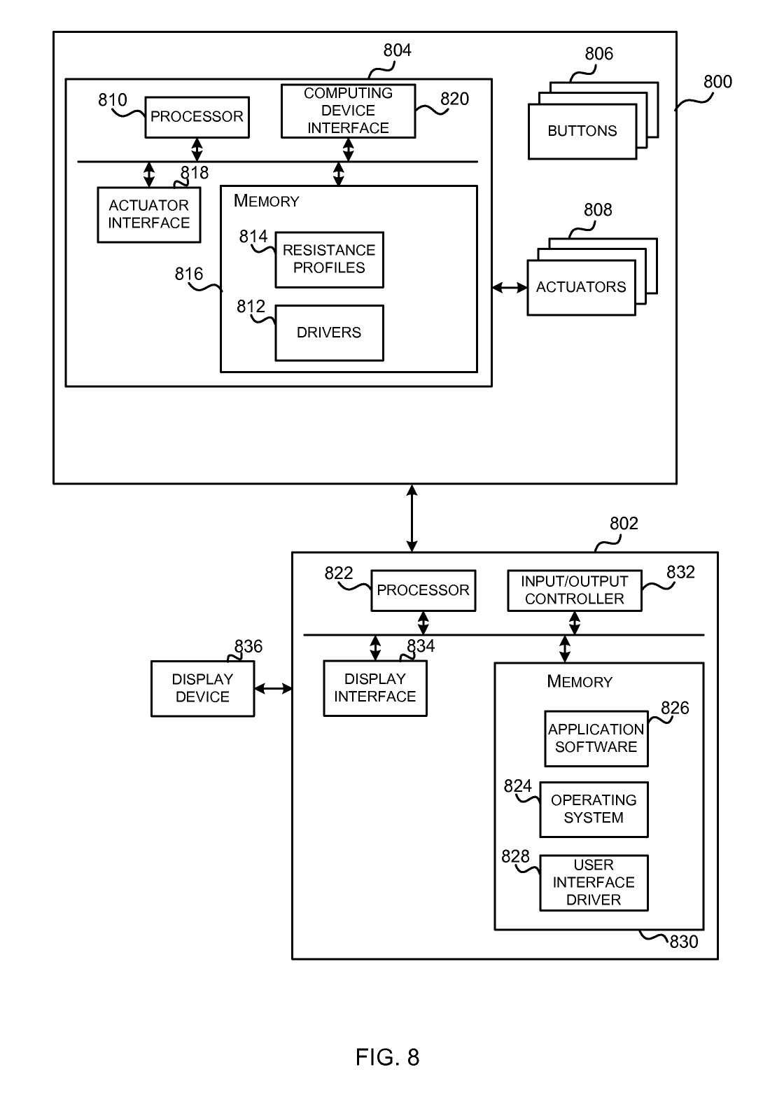

FIG. 8 illustrates various components of an exemplary improved user interface device 800 which may be connected to or integral with a computing-based device 802. The computing-based device 802 may be implemented as any form of a computing and/or electronic device, and where the computing-based device 802 and user interface device 800 are integrated and in some other implementations, some of the components shown separately in FIG. 8 may be combined (e.g. the functions of the interface element 804 may be performed by the elements shown within the computing-based device 802).

User interface device 800 comprises an interface element 804, two or more buttons 806 and at least one actuator 808. As described above, when actuated (e.g. by control signals received from the interface element 804) the actuators change the physical position of one or more buttons, where the position or motion of at least two buttons is linked or inter-related.

The interface element 804 comprises one or more processors 810 which may be microprocessors, controllers or any other suitable type of processors for processing computing executable instructions to control the operation of the actuators in order to change the position of buttons, as described above. In some examples, for example where a system on a chip architecture is used, the processors 810 may include one or more fixed function blocks (also referred to as accelerators) which implement a part of the method of controlling the actuators in hardware (rather than software or firmware). The computer executable instructions, such as actuator driver software 812 and/or resistance profile data 814 (e.g. as described above with reference to FIG. 4) may be provided using any computer-readable media that is accessible by the interface element 804. Computer-readable media may include, for example, computer storage media such as memory 816 and communications media. Computer storage media, such as memory 816, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device. In contrast, communication media may embody computer readable instructions, data structures, program modules, or other data in a modulated data signal, such as a carrier wave, or other transport mechanism. Although the computer storage media (memory 816) is shown within the interface element 804 it will be appreciated that the storage may be distributed or located remotely and accessed via a network or other communication link.

The interface element 804 also comprises an actuator interface 818 which provides an interface to the actuators 808 in the user interface device 800 and a computing device interface 820 which provides an interface for communication with the computing-based device 802.

Computing-based device 802 comprises one or more processors 822 which may be microprocessors, controllers or any other suitable type of processors for processing computing executable instructions to control the operation of the device. In some examples, for example where a system on a chip architecture is used, the processors 822 may include one or more fixed function blocks (also referred to as accelerators) which implement a part of the method of operation of the device in hardware (rather than software or firmware). Platform software comprising an operating system 824 or any other suitable platform software may be provided at the computing-based device to enable application software 826, which may include drivers 828 (which may be dedicated drivers) for the user interface device 800, to be executed on the device.

The computer executable instructions may be provided using any computer-readable media that is accessible by computing-based device 802. As described above, computer-readable media may include, for example, computer storage media such as memory 830 and communications media. Although the computer storage media (memory 830) is shown within the computing-based device 802 it will be appreciated that the storage may be distributed or located remotely and accessed via a network or other communication link (e.g. using a communication interface not shown in FIG. 8).

The computing-based device 802 also comprises an input/output controller 832 arranged to communicate with the user interface device 800 to receive and process user input signals and to provide control signals used by the interface element 804 to actuate the actuators 808 and move buttons 806. The computing-based device 802 further comprises a display interface 834 arranged to output display information to a display device 836 which may be separate from or integral to the computing-based device 802. This display information may provide a graphical user interface with which the user may interact using the user interface device 800.

It will be appreciated that both the user-interface device 800 and the computing-based device 802 may comprise additional elements not shown in FIG. 8 and only those elements which relate to the improved functionality of the user interface device 800 are shown.

### Conclusions

There are many applications for the improved user interface devices described herein and various example applications have been described above. Further example applications include industrial control systems (e.g. factories, power plants, warehouse management etc), flight control systems, rehabilitation devices, accessibility support for the elderly, infirm, or those with physical impairments, devices for infants with less developed motor control and multi-mode devices where precision can be traded off for speed or ease of input, such as mobile phones for dialing vs. sending of text (e.g. SMS) messages.

Although the present examples are described and illustrated herein as being implemented in a computing-based system where the user interface device is a peripheral device, the system described is provided as an example and not a limitation. As those skilled in the art will appreciate, the present examples are suitable for application in a variety of different types of systems and the user interface device may form part of an integrated device.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A user interface device comprising:
a plurality of physical buttons; and
an actuator arranged to control motion of a button under software control,
wherein the control of at least two buttons is inter-related.

2. A user interface device according to claim 1, further comprising:
an interface element arranged to receive input signals from a software program and to output control signals to the actuator to control the motion of a button based on the input signals received.

3. A user interface device according to claim 2, wherein the actuator is a servo motor and wherein the interface element is further arranged to detect user applied force by measuring a position signal output from the servo motor.

4. A user interface device according to claim 3, wherein the interface element is further adapted to output data representative of the user applied force to the software program.

5. A user interface device according to claim 2, further comprising a sensor located on a button and wherein the interface element is further arranged to receive a signal from the sensor and to output control signals to the actuator to move the button in response to detection of a finger above the sensor.

6. A user interface device according to claim 1, wherein the user interface device is a pointing device.

7. A user interface device according to claim 1, comprising a plurality of actuators, each actuator associated with a button and arranged to control the motion of the button under software control.

8. A user interface device according to claim 7, wherein at least one actuator is further arranged to move an associated button under software control such that the button moves in synchronization with a second button when depressed by a user.

9. A user interface device according to claim 1, wherein the actuator is further arranged to control the motion of a button under software control such that a user cannot depress the button.

10. A user interface device according to claim 9, wherein controlling the motion of a button such that it cannot be depressed by a user comprises automatically depressing the button under software control.

11. A user interface device according to claim 1, wherein in use the control of motion of buttons provides feedback to a user.

12. A method of controlling a user interface device, the user interface device comprising a plurality of physical buttons and at least one actuator arranged to control motion of a button, and the method comprising:
receiving a control signal from a software program; and
outputting control signals to at least one actuator to control motion of at least two buttons on the user interface device,
wherein the control of at least two buttons is inter-related.

13. A method according to claim 12, wherein the control signal received from the software program is indicative of a current location of a cursor within a graphical user interface of the software program.

14. A method according to claim 12, wherein the control signal received from the software program is indicative of a current state of the software program.

15. A method according to claim 12, further comprising:
detecting a force applied to a button; and
outputting a control signal to the software program based on the detected force.

16. A method according to claim 12, wherein the motion provides feedback to a user about the software program.

17. A method according to claim 12, wherein the outputting control signals to at least one actuator comprises:
outputting control signals to at least one actuator to control motion of a group of buttons such that they cannot be depressed by a user.

18. A method according to claim 17, wherein the group of buttons is selected dependent upon a current state of the software program.

19. A reconfigurable user input device comprising:
a plurality of buttons;
an electro-mechanical actuator associated with each button and arranged to change a position of the button; and
an interface element arranged to receive input signals from a software application and to output control signals to at least one actuator to control motion of at least one button based on the input signals received and wherein the control of at least two buttons is inter-related.

20. A reconfigurable user input device according to claim 19, wherein the interface element comprises:
a processor; and
a memory arranged to store executable instructions which, when executed, cause the processor to:
receive an input signal from a software program; and
output control signals to at least two actuators to control the motion of at least two buttons such that their motion is inter-related.
